(19) United States
(12) Patent Application Publication
(10) Pub. No.: US 2019/0250329 A1
(43) Pub. Date: Aug. 15, 2019

(54) Optical Waveguide Processors For Integrated Optics

(71) Applicant: Nokia Solutions and Networks Oy, Espoo (FI)

(72) Inventors: Argishti Melikyan, Matawan, NJ (US); Po Dong, Morganville, NJ (US)

(73) Assignee: Nokia Solutions and Networks Oy, Espoo (FI)

(21) Appl. No.: 15/897,478

(22) Filed: Feb. 15, 2018

(51) Int. Cl. G02B 6/125; G02B 6/122

(52) U.S. Cl. CPC G02B 6/125; G02B 2006/12061; G02B 6/1228

(57) ABSTRACT

An apparatus includes a substrate having a planar surface and an optical waveguide having an optical core located on said substrate. The optical core is along and may even be parallel to said surface. A cross section of the optical core varies throughout a segment of the optical core. A light guiding direction of the optical waveguide bends through, at least, 90 degrees along the segment.

### BACKGROUND

### Technical Field

The invention relates to optical components, optical communication systems with such optical components, and methods of using optical components.

### Related Art

This section introduces aspects that may be help to facilitate a better understanding of the inventions. Accordingly, the statements of this section are to be read in this light and are not to be understood as admissions about what is prior art or what is not prior art. Planar optical integration has a potential for producing smaller and/or cheaper optical devices and systems. Such optical devices may include planar optical waveguide devices that can be used in optical communications and optical sensors.

### SUMMARY OF SOME ILLUSTRATIVE EMBODIMENTS

Various embodiments provide planar optical devices, e.g., integrated optical devices, which are configured to process received light, e.g., passively process. The various embodiments may include optical waveguide(s) that adiabatically process light therein, e.g., to reduce optical losses that might be otherwise be caused by exciting non-fundamental and/or radiation optical propagation modes. The various optical devices include one or more optical waveguides with bent and/or coiled and/or spiraled segments that provide light processing, e.g., passively, and have smaller areas or footprints along a planar surface of a substrate.

In a first embodiment, an apparatus includes a substrate having a planar surface and an optical waveguide having an optical core located on said substrate. The optical core is along and may even be parallel to said surface. A cross section of the optical core varies throughout a segment of the optical core. A light guiding direction of the optical waveguide bends through, at least, 90 degrees along the segment.

In some such embodiments, the light guiding direction of the optical waveguide may bend through, at least, 180 degrees or more along the segment or even may bend through 270 degrees or more along the segment.

In any of the above embodiments, the light guiding direction of the optical waveguide may smoothly bend through, at least, 90 degrees or even, at least 180 degrees, along the segment.

In some of the above embodiments, a width of the optical core along the surface may smoothly vary throughout the segment. The optical waveguide may be a buried optical waveguide. The optical waveguide may be a ridge optical waveguide, and the width may be a width of the ridge.

In some of the above embodiments, a height of a ridge of the optical core normal to the surface may smoothly vary over the segment, and the optical waveguide core may be a ridge optical waveguide.

In any of the above embodiments, the optical core may include a silicon or silicon nitride optical waveguide core.

In any of the above embodiments, the segment may include first and second end-connected sub-segments. Also, the light guiding direction of the first sub-segment may bend to the left along the surface through, at least, 90 degrees, and the light guiding direction of the second sub-segment may bend to the right along the surface through, at least, 90 degrees.

In any of the above apparatus, the segment may be configured to transform a fundamental optical propagation mode at an input of the optical waveguide into a fundamental optical propagation mode of different cross-sectional size at an output of the optical waveguide.

Second embodiments of the above apparatus may further include another optical waveguide having another optical core located on said substrate and along or even parallel to said surface. A cross section of the other optical core may vary throughout a segment of the other optical core, and a light guiding direction of the other optical waveguide may bend through, at least, 90 degrees along the segment of the other optical waveguide core.

In some of the second embodiments, sub-segments of the two segments may be near and along each other over a length such that light guided by either of the segments optically couples to the other of the segments along the length. In some such embodiments, the light guiding directions of the two sub-segments may bend together through, at least, 180 degrees. In any embodiments of this paragraph, the sub-segments may have widths along the surface varying smoothly along the length. In any embodiments of this paragraph, the sub-segments may bend together such that a light propagation direction of the planar optical waveguides deviates to the left along the surface by at least 90 degrees, and the sub-segments may also bend together such that the light propagation direction of the planar optical waveguides deviates to the right along the surface by at least 90 degrees.

In any of the second embodiments, the apparatus may further include an optical polarization splitter and/or rotator including the optical waveguides.

In any of the second embodiments, the apparatus may further include a 1×2 optical coupler including the optical waveguides.

In any of the second embodiments, the apparatus may further include, at least, an optical data transmitter, optical data receiver, or an optical amplifier including the substrate and optical waveguides.

### BRIEF DESCRIPTION OF THE DRAWINGS

FIGS. 1a, 1b, 1c, and 1d are top views of different embodiments of optical propagation-mode-converters;

FIGS. 2A and 2B are cross-sectional views through different embodiments of the planar optical waveguides of FIGS. 1a, 1b, 1c, and 1d;

FIGS. 3a, 3b, 3c, and 3d are top views of planar optical devices with two coupled planar optical waveguides; and

FIG. 4 is a flow chart illustrating a method of operating the various optical devices of FIGS. 1a-1d, 2A, 2B, and 4a-4d;

FIG. 5 illustrates an optical propagation-mode-converter, e.g., based on the planar optical waveguides of FIGS. 1a-1d; and

FIG. 6 illustrates a 1×2 or 2×2 optical coupler, e.g., based on the planar optical devices of FIGS. 3a-3d.

In the Figures, relative dimension(s) of some feature(s) may be exaggerated to more clearly illustrate the feature(s) and/or relation(s) to other feature(s) therein.

In the various Figures, similar reference numbers may be used to indicate similar structures and/or structures with similar functions.

Herein, various embodiments are described more fully by the Figures and the Detailed Description of Illustrative Embodiments. Nevertheless, the inventions may be embodied in various forms and are not limited to the embodiments described in the Figures and the Detailed Description of Illustrative Embodiments.

### DETAILED DESCRIPTION OF ILLUSTRATIVE EMBODIMENTS

Various embodiments of planar optical devices include bent optical waveguide cores, which are configured to process light therein, e.g., via optical propagation mode conversion or via optical evanescent coupling to a nearby and substantially parallel optical waveguide,

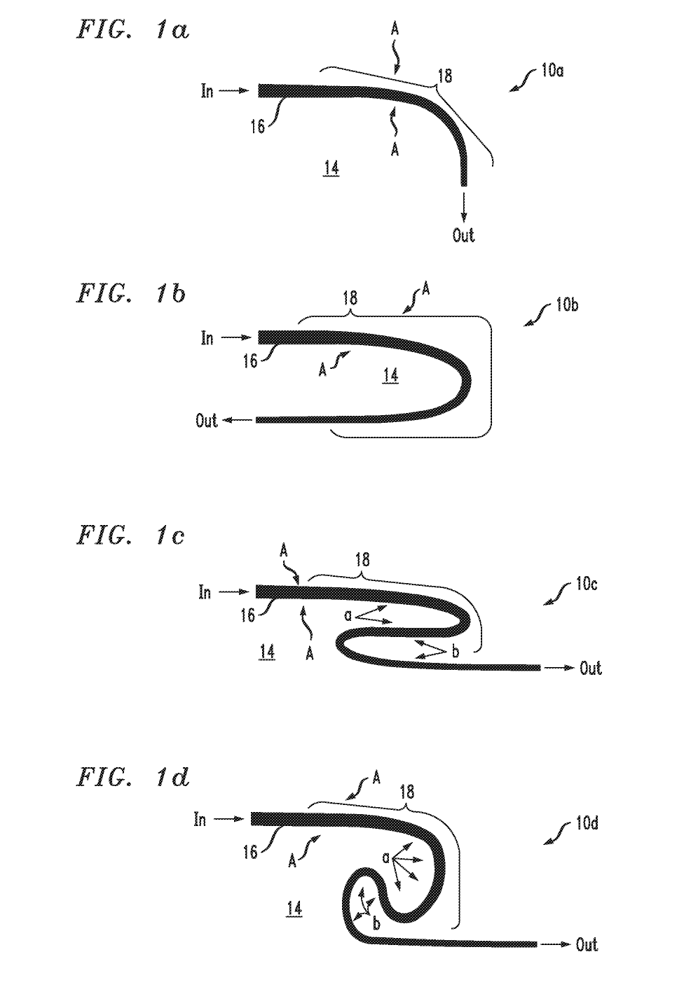

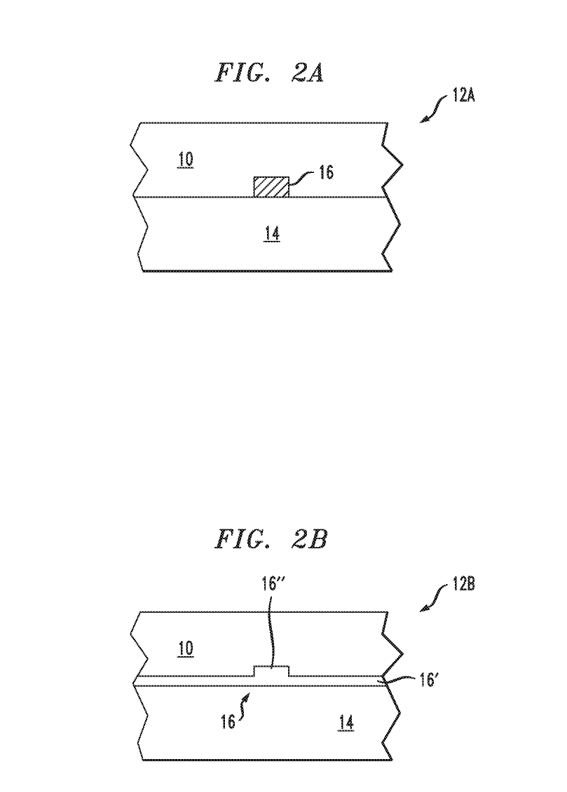

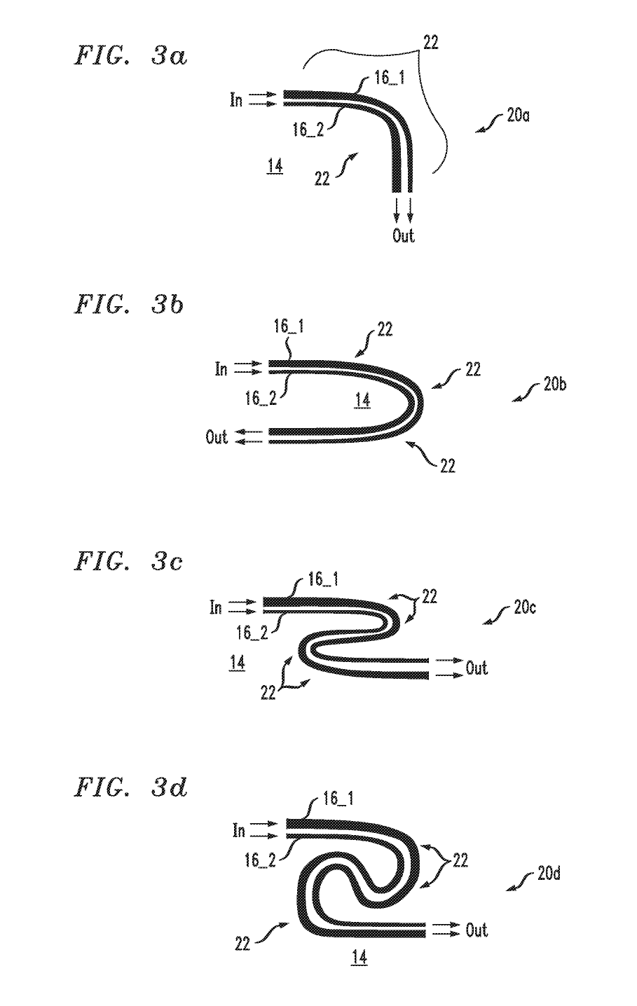

FIGS. 1a, 1b, 1c, and 1d are top views of first, second, third, and fourth embodiments of optical propagation-mode-converters 10a, 10b, 10c, 10d, e.g., converters of the lateral intensity profile of a propagating optical mode. The optical propagation-mode- converters 10a-10d include an optical input (herein referred to as “In”), an optical output (herein referred to as “Out”), and a planar optical waveguide connecting the optical input “In” to the optical output “Out”. The planar optical waveguide includes an optical core 16 located along a surface of a substrate 14, e.g., a planar major surface of the substrate 14. The optical core 40 may be directly on the surface or may be near a parallel to the surface. The optical core 16 is typically laterally completely or partially surrounded by an optical cladding material 10 of lower optical refractive index (see, e.g., FIGS. 2A-2B).

The planar optical waveguide includes a segment 18 for performing optical propagation-mode-conversion, e.g., passively. On this segment 18, the cross section of the optical core 16 typically varies, e.g., in one or more lateral linear dimensions, along a light propagation or guiding direction. e.g., the cross section may vary smoothly throughout the entire segment 18 for optical propagation-mode-conversion. The variation of the cross section may be a variation of one or more widths of the optical core 16 along the nearby surface of the substrate 14 and/or may be a variation of one or more heights of the optical core 16 in a direction normal to the nearby surface of the substrate 14. It is noted that FIGS. 1a-1d explicitly illustrate a variation of a width of the optical core 16 along the surface of the substrate 14 even though a different or more general form of the variation of the cross section of the optical core 16 is within scope of the embodiments described herein. The variation of cross section of the optical core 16 causes the form and/or size of the optical propagation mode(s) of the optical waveguide 16 to vary. For example, the variation may be an adiabatic variation of the optical waveguide that causes light of a fundamental optical propagation mode, at the input “In”, to be converted into light of a fundamental optical propagation mode, e.g., of different lateral size, at the output “Out”. That is, the variation of width(s) and/or height(s) of the optical core 16 may be such that light input to the optical fundamental propagation mode is output in an optical fundamental mode so that light loss is very low in the segment 18. Such variations of the height(s) and/or width(s) of the optical core 16 may depend linearly or nonlinearly on the distance along the light guiding direction in the optical waveguide and may be monotonic or non-monotonic along said light guiding direction in the optical waveguide in the segment 18. The lateral cross section of the optical core 16 may be changed along the propagation direction in a way that the radiation losses are at minimum for a given length.

In the segment 18 for optical propagation-mode-conversion or a substantial sub-segment thereof, the optical core 16 bends along or about parallel to the surface of the substrate 14. Due to this bending, a light guiding direction of the optical waveguide or the optical core 16 bends through an angle of 90 degrees or more, e.g., as illustrated in FIG. 1a, through an angle of 180 degrees or more, e.g., as illustrated in FIGS. 1b, 1c, and 1d, or even through an angle of about 270 degrees or more, e.g., as illustrated in FIG. 1d. In the embodiments 10c and 10d of FIGS. 1c and 1d, the optical core 16 has a sequence of end-connected sub-segments “a” and “b”. The light guiding direction of the “a” sub-segment bends, e.g., to the right, along the surface of the substrate 14, through 90 degrees or more, and the light guiding direction of the “b” sub-segment bends to the left along the surface of the substrate 14 through 90 degrees or more in these embodiments. In other unshown embodiments, the optical core 16 may be formed of sequence of sub-segments that causes the light guiding direction of the first sub-segment to bend to the left along the surface of the substrate 14 through, at least, 90 degrees, and that causes the light guiding direction of the second sub-segment to bend to the right along the surface of the substrate 14 through, at least, 90 degrees. In the embodiments 10c and 10d, the optical core 16 of the optical waveguide has an S-like shape or a shape with more bends, e.g., a spiral in the segment 18 for optical propagation-mode-conversion.

In various embodiments, the bent form of the optical core 16 may not cause large or unacceptable optical losses in the segment 18 for optical propagation-mode-conversion even if some or all of the bends of the optical core 16 have small bending radii. At such bend(s), the optical losses may be small or insignificant, because the optical core 16 has a high index contrast with respect to laterally surrounding optical cladding(s). For example, the optical core 16 may be a silicon or a silicon nitride structure and the optical cladding(s) may be silica glass so that the optical core-cladding contrast in refractive index is higher than the value typically available in optical waveguides whose optical cores and optical claddings are both fabricated with silica glasses and/or doped silica glasses.

Due to the bent form of the optical cores 16 of the embodiments 10a-10d of FIGS. 1a-1d, the segment 18 for optical propagation-mode-conversion can be fabricated adjacent a small or well-localized area or footprint along the surface of the substrate 14. Thus, the bent forms of the optical cores 16 can enable fabrication of planar optical devices on small areas of an optical chip without entailing large or even significant optical losses.

FIGS. 2A and 2B are cross-sectional views of different exemplary first and second embodiments 12A, 12B of the optical waveguides 16 of FIGS. 1a-1d, i.e., cross-sectional views along lines A-A in FIGS. 1a-1d. In FIG. 2A, the optical waveguide 12A includes an optical core 16, which is buried by one or more layers of optical cladding 10. In FIG. 2B, the optical core 16 includes a planar core layer 16′ and a guiding ridge 16″ thereon. The core layer 16′ is located on a surface of the substrate 14, and the core layer 16′ and ridge 16″ are laterally covered above by one or more layers of optical cladding 10. In FIGS. 2A and 2B, the optical core 16 has a higher optical refractive index than the substrate 14 and the surrounding optical cladding 10.

FIGS. 3a, 3b, 3c, and 3d are top views of different embodiments 20a, 20b, 20c, and 20d of planar optical devices having two planar optical waveguides. The planar optical devices 20a -20d have a pair of optical cores 16_1, 16_2, which are optically side-coupled throughout an optical interaction region 22, e.g., via evanescent light. In the interaction region 22, each optical core 16_1, 16_2 guides light such that the guided light overlaps the other of the optical cores 16_2, 16_1. That is, the evanescent field of the optical mode primarily or substantially guided by one of the optical cores 16_1, 16_2 overlaps the other optical core 16_2, 16_1 in the interaction region 22. Typically, due to the optical coupling in the interaction region 22, injecting light into the input “In” of one of the optical cores 16_1, 16_2 can cause some of the injected light to be ejected at the output “Out” of the other of the optical cores 16_2, 16_1. In some embodiments, injecting light into the input “In” of either of the optical cores 16_1, 16_2 can cause some of the light to be ejected at the output “Out” of the other of the optical cores 16_2, 16_1.

In part of the interaction region 22, the optical cores 16_1, 16_2 of the two optical waveguides bend substantially or approximately together along the surface of the substrate 14, e.g., parallel to a nearby planar major surface of the substrate 14. Due to this bending, a light guiding direction of each optical waveguide and each optical core 16_1, 16_2 may bend through an angle of 90 degrees or more along the surface of the substrate 14, e.g., as illustrated in the embodiments 20a-20d of FIGS. 3a-3d; through an angle of 180 degrees or more along the surface, e.g., as illustrated in the embodiments 20b-20d of FIGS. 3b, 3c, and 3d; or even through an angle of about 270 degrees or more along the surface, e.g., as illustrated in the embodiment 20d of FIG. 3d. In the embodiments 20c, 20d of FIGS. 3c and 3d, the optical cores 16_1, 16_2 have a sequence of end-connected sub-segments “a” and “b”. The light guiding direction of the “a” sub-segments bend together, e.g., to the right, along the surface of the substrate 14, through 90 degrees or more, and the light guiding direction of the “b” sub-segments bend together to the left along the surface of the substrate 14 through 90 degrees or more in these embodiments 20c, 20d. In other unshown embodiments, the optical cores 16_1, 16_2 may be formed of a sequence of sub-segments that cause the light guiding direction of the first sub-segments to bend to the left along the surface of the substrate 14 through, at least, 90 degrees, and that cause the light guiding direction of the second sub-segments to bend to the right along the surface of the substrate 14 through, at least, 90 degrees. In the embodiments 20c and 20d, the optical cores 16_1, 16_2 of the optical waveguide have S-like shapes or shapes with more bends like spirals in circular or rectangular with rounded corners shapes in the optical interaction region 22.

In various embodiments, the bent forms of the optical cores 16_1, 16_2 may not cause large optical losses in the optical interaction region 22 even if some or all of the bends of the optical cores 16_1, 16_2 have small approximate bending radii. At such bend(s), the optical losses may be small, acceptable or even insignificant, because the optical cores 16_1, 16_2 have a high index contrast with respect to laterally surrounding optical cladding(s). For example, the optical cores 16_1, 16_2 may be silicon or a silicon nitride structures and the optical cladding(s) may be silica glass so that the optical core-optical cladding contrast, in optical refractive index, is higher than the value typically available in optical waveguides whose optical cores and optical claddings are both fabricated with silica glasses and/or doped silica glasses.

Due to the bent together form of the optical cores 16_1, 16_2 of the embodiments 20a-20d of FIGS. 3a-3d, the optical interaction region 22 can have small area or footprint along the surface of the substrate 14. Thus, the bending together of the pair of adjacent optical cores 16_1, 16_2 can enable the fabrication of planar optical devices on small areas of an optical chip without entailing large or even significant light losses during operation.

In the interaction region 22, the segments of the adjacent optical waveguides process light propagating therein, e.g., passively. For some embodiments, the cross sections of the optical cores 16_1, 16_2 may vary in the interaction region 22, e.g., vary in one or more lateral linear dimensions, along light propagation or guiding directions. Indeed, such variations of the cross sections may be smooth throughout the entire interaction region 22 or only over adjacent sub-segments of the optical cores 6_1, 16_2 therein. The variation of the cross sections may be variations of one or more widths of the optical cores 16_1, 16_2 along the nearby surface of the substrate 14 and/or may be variations of one or more heights of the optical cores 16_1, 16_2 in a direction normal to the nearby surface of the substrate 14. It is noted that FIGS. 3a-3d explicitly illustrate variations of widths of the optical cores 16_1, 16_2 along the surface of the substrate 14 even though a different or more general form of the variation of the cross sections of the optical cores 16_1, 16_2 is within scope of the embodiments described herein. The variation of cross sections of the optical cores 16_1, 16_2 may cause the form and/or size of the optical propagation mode(s) of the optical waveguide 16 to vary so that said modes overlap more or less the adjacent or other optical core 16_2, 16_1. For example, the variation may be an adiabatic variation of the optical waveguides that cause, at most, low light losses. Such variations of the height(s) and/or width(s) of the optical core 16 may depend linearly or nonlinearly on the distance along the light guiding direction in the optical waveguide and may be monotonic or non-monotonic along said light guiding direction in the optical waveguide in the segment 18. The lateral cross sections may be varied along the propagation direction in so that the radiation losses and intermodal couplings are at minimum for a given length.

As illustrated in FIGS. 3a-3D, the paired and optically coupled optical cores 16_1, 16_2 may have cross sections that vary in an opposite manner along the combined light propagation direction in the interaction region 22, e.g., to aid in the optical processing therein. For example, a linear lateral dimension of the optical core 16_1 may become larger along a propagation direction, for which the same lateral dimension of the other optical core 16_2 may become smaller.

In FIGS. 3a-3d, each of the optical cores 16_1, 16_2 may be, e.g., a buried optical core 16, as illustrated in FIG. 2A, or may be a core layer 16′ with a guiding ridge 16″, as illustrated in FIG. 2B.

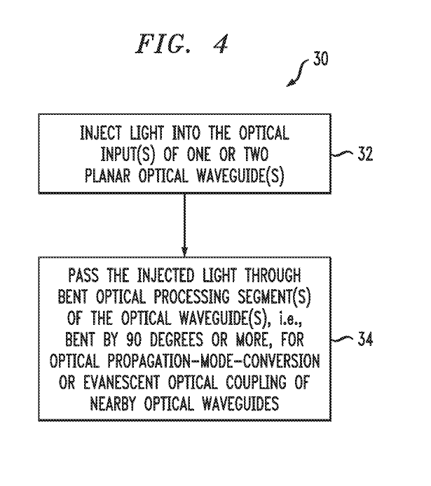

FIG. 4 is a flow chart illustrating a method 30 of operating various optical devices, e.g., the optical devices 10a-10d and 20a-20d of FIGS. 1a-1d, 2A, 2B, and 3a-3d.

The method 30 includes injecting light into the optical input(s) of one or two planar optical waveguides (step 32). For example, the optical waveguides may be any of the embodiments 10a-10d and 20a-20d of FIGS. 1a-1d and 3a-3d.

The method 30 includes passing the injected light through substantially bent optical processing segment(s) of the optical waveguide(s) for optical propagation-mode-conversion or evanescent optical coupling of adjacent nearby and approximately parallel optical waveguides (step 34). In the processing segment(s), the optical core(s) of the optical waveguide(s) have one or more bends of 90 degrees or more, 180 degrees or more, or even 270 degrees or more. In some embodiments, said optical processing segment(s) may have bends to both the left and the right along a nearby planar surface of a substrate, wherein the bends are through 90 degrees or more. The processing segment(s) may be, e.g., the segments 18 of FIGS. 1a-1d and/or the interaction regions 22 of FIGS. 3a-3d.

FIG. 5 illustrates an optical propagation-mode-converter 10, e.g., optical devices 10a-10d of FIGS. 1a-1d, that may convert the lateral size of an optical propagation mode between input and output optical waveguides I and O. For example, the input and output optical waveguides I and O may have fundamental optical propagation modes of different lateral dimensions.

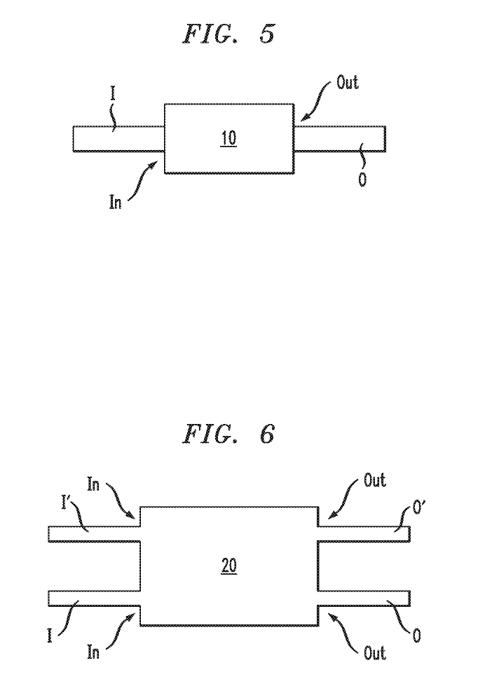

FIG. 6 illustrates a 1×2 or 2×2 optical coupler 20, e.g., one of the optical devices 20a-20d of FIGS. 3a-3d. The optical coupler 20 may symmetrically or asymmetrically power split light received from one optical input waveguide I between the two optical output optical waveguides O, O′. Alternately, the optical coupler 20 may polarization split light received from one optical input waveguide I between the two optical output optical waveguides O, O′. Alternately, the optical coupler 20 may optically mix light received from the two optical input waveguides I, I′ between the two optical output optical waveguides O, O′, e.g., as performed in a 90 degree optical hybrid in a coherent optical receiver.

The Detailed Description of the Illustrative Embodiments and drawings merely illustrate principles of the inventions. Based on the present specification, those of ordinary skill in the relevant art will be able to devise various arrangements that, although not explicitly described or shown herein, embody the inventions and are included within the scope of the claims. Also, statements herein reciting principles, aspects, and embodiments are intended to encompass equivalents thereof.

1. An apparatus, comprising:
a substrate having a planar surface;
an optical waveguide having an optical core located along said surface; and
wherein a cross section of the optical core varies throughout a segment of the optical core and a light guiding direction of the optical waveguide bends through, at least, 90 degrees along the segment, a variation of a width of the core being monotonic on the segment.

2. The apparatus of claim 1, wherein the light guiding direction of the optical waveguide bends through, at least, 180 degrees along the segment.

3. The apparatus of claim 2, wherein the light guiding direction of the optical waveguide smoothly bends through, at least, 90 degrees along the segment.

4. The apparatus of claim 2, wherein a width of the optical core along the surface smoothly varies throughout the segment, the optical waveguide being a buried optical waveguide.

5. The apparatus of claim 2, wherein a width of a ridge of the optical waveguide core along the surface smoothly varies throughout the segment, the optical waveguide being a ridge optical waveguide.

6. The apparatus of claim 2, wherein a height of a ridge of the optical core normal to the surface smoothly varies throughout the segment, the optical waveguide core being a ridge optical waveguide.

7. The apparatus of claim 1, wherein the optical core includes a silicon or silicon nitride optical waveguide core.

8. The apparatus of claim 1, wherein the segment includes first and second end-connected sub-segments, the light guiding direction of the first sub-segment bending to the left along the surface through, at least, 90 degrees, and the light guiding direction of the second sub-segment bending to the right along the surface through, at least, 90 degrees.

9. The apparatus of claim 8, wherein the optical core includes a silicon or silicon nitride optical waveguide core.

10. The apparatus of claim 2, wherein the segment is configured to transform a fundamental optical propagation mode at an input of the optical waveguide into a fundamental optical propagation mode of different cross-sectional size at an output of the optical waveguide.

11. An apparatus, comprising:
a substrate having aplanar surface;
an optical waveguide having an optical core located along said surface_{;} a cross section of the optical core varying throughout a segment of the optical core and a light guiding direction of the optical waveguide bending through, at least, 90 degrees along the segment; and
another optical waveguide having another optical core located along said surface; and
wherein a cross section of the other optical core varies throughout a segment of the other optical core, a light guiding direction of the other optical waveguide bending through, at least, 90 degrees along the segment of the other optical core, the optical cores being optically side-coupled throughout the segments.

12. (canceled)

13. The apparatus of claim 11, wherein the light guiding directions of the two segments bend together through, at least, 180 degrees.

14. The apparatus of claim 11, wherein the segments have widths along the surface varying smoothly along the segments.

15. The apparatus of claim 11, wherein the segments bend together such that a light propagation direction of the planar optical waveguides deviates to the left along the surface by at least 90 degrees and the segments bend together such that the light propagation direction of the planar optical waveguides deviates to the right along the surface by at least 90 degrees.

16. The apparatus of claim 11, further comprising an optical polarization splitter including the optical waveguides.

17. The apparatus of claim 11, further comprising a 1×2 optical coupler including the optical waveguides.

18. The apparatus of claim 11, further comprising ate least, an optical data transmitter, optical data receiver, or an optical amplifier including the substrate and the optical waveguides.
